(19) United States
(12) Patent Application Publication
(10) Pub. No.: US 2007/0065644 A1
(43) Pub. Date: Mar. 22, 2007

(54) Sound-insulating composite component and method for the production thereof

(75) Inventor: Heinz Blomeling, Leichlingen (DE)

Correspondence Address: WILLIAM COLLARD;COLLARD & ROE, P.C., 1077 NORTHERN BOULEVARD, ROSLYN, NY, 11576, US

(73) Assignee: CARCOUSTICS TECH CENTER GMBH, Leverkusen (DE)

(21) Appl. No.: 10/566,013

(22) PCT Filed: Jul. 22, 2004
(86) PCT No.: PCT/EP04/08202

§ 371 Date: Feb. 28, 2006

(30) Foreign Application Priority Data
Jul. 25, 2003 (DE) 103 34 274.5

(51) Int. Cl. B29C 43/00; B32B 3/12

(52) U.S. Cl. 428/158; 264/324; 264/325; 264/321; 428/172

(57) ABSTRACT

The invention relates to a sound-insulating composite component and a method for its production. The composite component (38) is in particular destined for motor vehicles and comprises a heavy layer (6) and a sound-attenuation layer (17) that is connected with said heavy layer and is made of porous and/or textile material. The heavy layer is formed as a moulded part by extrusion-pressing a plasticized plastic compound, fed-in in the strand placement process, from the group of thermoplastic elastomers, comprises regions of different thickness and/or density and is welded to the sound attenuation layer (17) only in some parts, wherein the sound attenuation layer has a profile structure that is formed by thermal forming, and at least in some sections the circumference of the sound attenuation layer (17) reaches beyond the circumference of the heavy layer (6). The production method comprises the following steps: placing a certain volume of a heavy-layer material as a plasticized compound into an open cavity of a press comprising a lower die and an upper die; closing the press, wherein the plasticized compound is extrusion-pressed into the form of the heavy layer defined by the lower die and the upper die; opening the press; arranging the sound attenuation layer in the form of a web, a blank or an injection moulded part on the heavy layer; and
partial welding together of the heavy layer (6) and the sound attenuation layer (17) by closing the press or a further press and by activating several welding elements that are delimited in area and that are integrated in the press or in the further press. The composite component obtained in this way is characterised by favourable recycling characteristics and relatively low production costs.

The invention relates to a sound-insulating composite component and a method for the production thereof. The composite component is in particular destined for motor vehicles and comprises a heavy layer and a sound-attenuation layer that is connected with said heavy layer and is made of porous and/or textile material.

In order to produce sound-insulating composite components, a multitude of different methods have become known in the state of the art. DE 37 41 692 A1 describes a method for producing a sound-insulating composite component in which a plastic carrier component is connected to an attenuation component based on a foam material. This method is essentially characterised in that between the carrier component and the attenuation component a sound insulation component in the form of a heavy foil is arranged, wherein the carrier component and the sound insulation component prior to the components being connected are heated to a state where they are soft and pliable, whereupon the carrier component, the insulating component and the attenuation component are then interconnected by pressing. The parts of the composite component obtained in this way are interconnected by immediate mutual penetration.

From DE 40 30 964 A1 a method for producing a plastic formed part is known, in which method the plastic compound after plasticizing is fed to an open mould cavity of a form tool made of a top and lower die half, and is compression moulded. In this method the plasticized plastic compound is compression moulded against at least one decorative material web tensioned against the tool halves. Furthermore, a tentering frame is used that is able to close the cavity border like a positive edge. Single-layer or multi-layer plastic films, woven fabrics, knitted fabrics, felts and the like, if necessary lined with a foam backing or the like, are used as decorative material webs. The formed plastic part produced in this way is subjected to a contour cut using a separating blade arranged on the tentering frame.

Starting from this state of the art it is the object of the present invention to state a method for producing a sound-insulating composite component of the type mentioned in the introduction, with which method such composite components can be economically produced in particular in the case of relatively large dimensions, for example as dash panel for a motor vehicle, wherein the finished composite components have to have favourable recycling characteristics. Furthermore, it is the object of the invention to create a corresponding composite component.

As far as the method is concerned, this object is met by a method with the features of claim 1. The method according to the invention essentially comprises the following steps:
placing a certain volume of a heavy-layer material as a plasticized compound into an open cavity of a press comprising a lower die and a upper die;
closing the press, wherein the plasticized compound is extrusion-pressed into the form of the heavy layer defined by the lower die and the upper die;
opening the press;
arranging the sound attenuation layer in the form of a web, a blank or an injection moulded part on the heavy layer; and
partial welding together of the heavy layer and the sound attenuation layer by closing the press or a further press and by activating several welding elements that are delimited in area and that are integrated in the press or in the further press.

The sound-insulating composite component has the features stated in claim 13. It is essentially characterised in that its heavy layer is formed as a moulded part by extrusion-pressing a plasticized plastic compound, fed-in in the strand placement process, from the group of thermoplastic elastomers, comprises regions of different thickness and/or density and is welded to a sound attenuation layer only in some parts, wherein the sound attenuation layer has a profile structure that is formed by thermal forming, and at least in some sections the circumference of the sound attenuation layer reaches beyond the circumference of the heavy layer.

The method according to the invention provides the opportunity to produce relatively large acoustically effective pieces of cladding, in particular firewall cladding for automotive use, comparatively economically. For, the method according to the invention makes it possible also to produce relatively large-area heavy layers from such plasticizable plastic compounds, in particular thermoplastic elastomers, that can be produced in injection moulding tools only with considerable difficulties, for example only with the use of expensively constructed injection moulding tools, or only with the addition of additives that have an influence on the flow characteristics. In contrast to this, the press tools required for implementing the method according to the invention are of comparatively simple construction and are thus available cost-efficient. During recycling of composite components according to the invention, the fact that the heavy layer and the sound attenuation layer are not interconnected over the entire area but instead are only partially connected, makes separation largely according to type between the heavy layer and the sound attenuation layer relatively easy. Furthermore, the method according to the invention makes possible essentially waste-free production of generic composite components.

For partial welding together of the heavy layer and the sound attenuation layer, the lower die and/or the upper die can be exchanged against a lower die or upper die that leads to an enlargement of the cavity defined by the lower die and the upper die. The enlargement of the cavity can in particular be provided at the margin of the heavy layer and/or in the region of an opening in the heavy layer.

Further preferred and advantageous embodiments of the invention are stated in the subordinate claims.

Below, the invention is explained in more detail with reference to a drawing showing several embodiments. The following are diagrammatically shown:

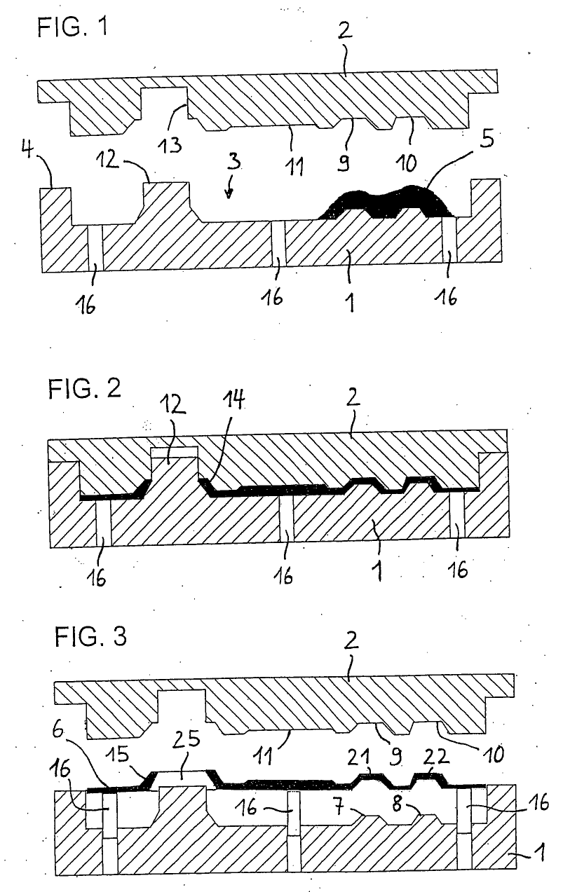

FIG. 1 a cross-sectional view of the lower die and the upper die of a mould press in their open state;

FIG. 2 a cross-sectional view of the form tools according to FIG. 1 in their closed state;

FIG. 3 a cross-sectional view of the form tools according to FIG. 1 in their re-opened state in which a moulded part produced with the form tools is ejected;

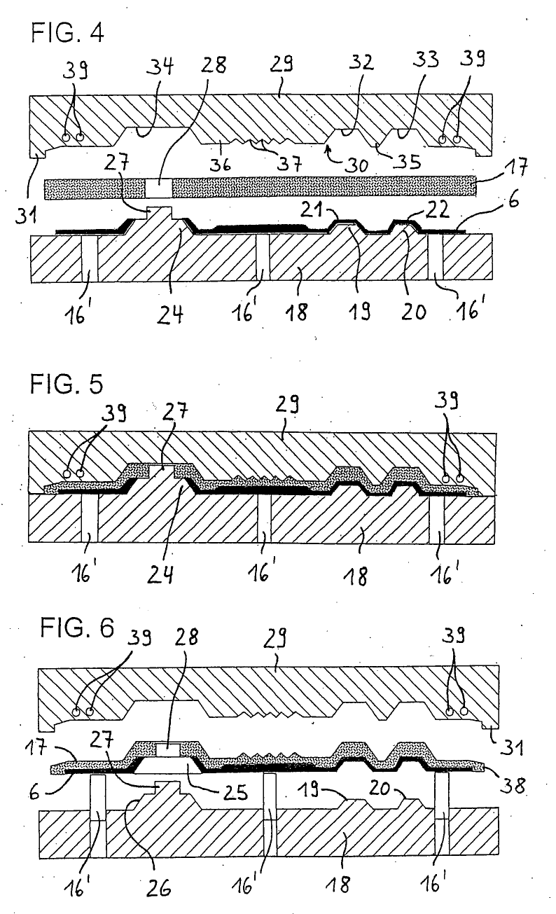

FIG. 4 a cross-sectional view of further form tools, comprising a cavity into which a moulded part that has been produced with the form tools according to FIG. 1 and a plate-shaped sound attenuation part are inserted;

FIG. 5 a cross-sectional view of the form tools according to FIG. 4 in their closed state;

FIG. 6 a cross-sectional view of the form tools according to FIG. 4 in their re-opened state, in which a composite component according to the invention, produced with the form tools, is ejected;

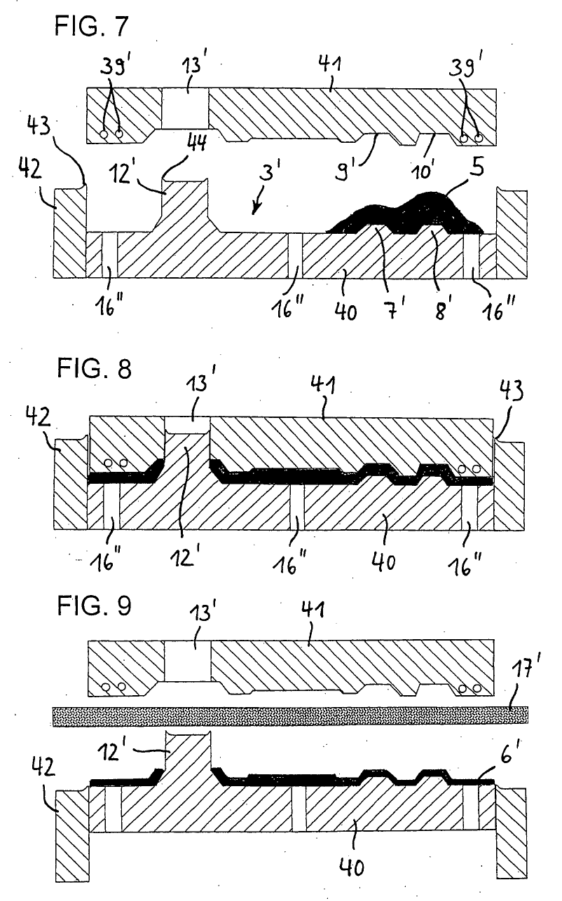

FIG. 7 a cross-sectional view of the lower die and the upper die of a mould press according to a further embodiment in their open state;

FIG. 8 a cross-sectional view of the form tools according to FIG. 7 in their closed state;

FIG. 9 a cross-sectional view of the form tools according to FIG. 7 in their re-opened state, wherein between the form tools a web section or a blank made of sound attenuation material is arranged above the moulded part that has previously been made with the form tools;

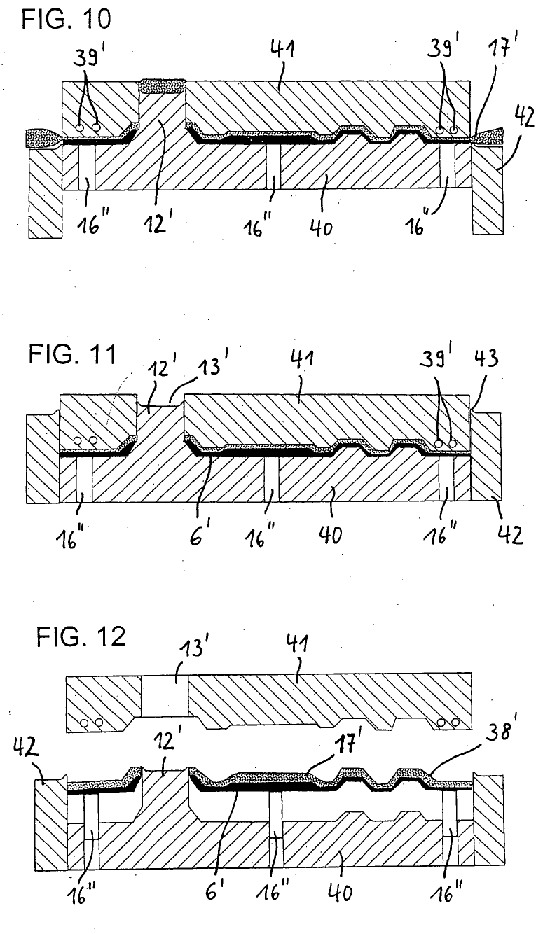

FIG. 10 a cross-sectional view of the form tools according to FIG. 7 in their re-closed state, in which the web section or blank made of sound attenuation material is pressed onto the moulded part that has previously been produced using the form tools;

FIG. 11 a cross-sectional view of the form tools according to FIG. 7 in their closed state, in which the web section or blank made of sound attenuation material is pressed onto the moulded part that has previously been produced using the form tools, and in which the web section or blank made of sound attenuation material has been cut on the margin side; and

FIG. 12 a cross-sectional view of the form tools according to FIG. 7 in their re-opened state, in which a composite part according to the invention, produced with the form tools, is ejected.

In FIGS. 1 to 3 reference number 1 denotes a lower form tool (lower die) and 2 an upper form tool (upper die) of a form press (not shown in detail) for producing a heavy layer of a sound-insulating composite component. The form tools 1, 2 are movable in relation to each other. In this arrangement the lower die 1 can for example be fixed while the upper die 2 can be moved towards and away from the lower die 1 by means of a hydraulic positioning device.

The lower die 1 comprises a mould cavity 3 which is defined by a circumferential positive edge 4. A defined volume of a heavy-layer material is placed as a plasticized compound 5 into the open cavity 3 in the strand placement process. The heavy-layer material is a highly filled plastic compound, preferably from the group of thermoplastic elastomers (TPE). In particular the thermoplastic polyolefin elastomers TPO or TPV can be used that comprise polypropylene with up to 65% incorporated ethylene propylene [diene] caoutchouc (EP[D]M). Also well suited are thermoplastic elastomers of the type TPS (styrene TPE) and compounds made of PE-EVA (polyethylene ethylene vinyl acetate).

Plasticization of the plastic compound 5 preferably takes place with the use of an extruder device. The plasticized compound is dosed in batches, wherein each batch essentially corresponds to exactly the volume of a heavy layer 6 to be produced. The respective heavy layer 6 is thus produced without any waste by placing a component-specific volume of the plasticized heavy-layer material into the cavity 3 of the lower die 1. It is within the scope of the invention to apply the plasticized compound 5, if necessary in a s-shaped line and/or at several positions, onto the bottom of the cavity 3. To this effect a mobile application device can be used which comprises an automatically movable discharge nozzle. Furthermore, it is within the scope of the invention to place plasticized heavy-layer compounds that are different in relation to their composition at certain positions of the cavity 3. The heavy-layer compounds can differ in particular in relation to their filler fraction so that the heavy layer 6 made thereof finally comprises areas of different density or weight per unit area.

The upper die 2 is designed such that it can plunge with very little play into the cavity 3. Within its cavity 3, the lower die 1 comprises several elevations 7, 8 that rise from the bottom. Correspondingly formed depressions 9, 10 in the underside of the upper die 2 are associated with these elevations. The elevations 7, 8 and depressions 9, 10 of the form tools 1, 2 cause the formation of a relief or a profile structure on the heavy layer 6. The profile structure can be used to adapt the heavy layer 6 or the composite component produced therefrom to aggregates, for example to aggregates in the engine compartment of a motor vehicle. The profile structure of the heavy layer 6 can however also, or exclusively, have an acoustic function.

The form tools 1, 2 are designed such that the heavy layer 6 produced with them comprises areas of different thickness. In this regard, FIGS. 1 to 3 show for example that the upper die 2 comprises an depression 11, wherein the lower die 1 at its position facing the depression 11 does not have an elevation but is essentially flat. The local thickness of the heavy layer 6 is selected depending on the acoustic requirements at the place of installation.

In the mould cavity 3 the lower die 1 further comprises one or several pin-shaped projections 12 with which corresponding holes or depressions 13 in the upper die 2 are associated. The projections are used, during the mould pressing procedure, to keep free of any plasticized heavy-layer material 5 the openings for feeding cable strands, media lines, mechanical elements or the like in the moulded part or composite part to be produced (compare FIG. 2). The pin-shaped projection 12 and the depression 13 associated with it, in the closed state of the form tools 1, 2, delimit a conically shaped annular space 14 into which part of the plasticized compound 5 can enter during the forming press procedure. In this way bush- or nozzle-like shapes 15 can be formed on the heavy layer 6, which bush- or nozzle-like shapes are used for the sealed-off leadthrough of electrical or other lines, for example if the composite component to be produced is the dash panel of a motor vehicle.

As soon as the plasticized plastic compound 5, as a result of the form tools 1, 2 being closed, is extrusion pressed into the shape of the heavy layer 6 and has adequate nondeformability, the form tools 1, 2 are re-opened and the heavy layer 6 is removed from the cavity 3. To this purpose preferably several retractable and extendable ejection elements 16 are integrated in the bottom of the lower die 1.

For partial connection and over-embossing with a sound attenuation layer 17 the heavy layer 6 produced in this way is then arranged on a second lower die 18, as shown in FIGS. 4 to 6. The diagram shows that the lower die 18 also comprises elevations 19, 20, which as far as their shape and arrangement are concerned correspond to the elevations 7, 8 of the lower die 1 according to FIGS. 1 to 3 and are used to accommodate the outward bulges 21, 22 in the heavy layer 6.

Furthermore, the lower die 18 according to FIGS. 4 to 6 comprises a projection 24 which is used to accommodate the opening 25 in the heavy layer 6. The projection 24 consists of a section 26 in the shape of a truncated cone, and an upper stepped cylindrical section 27. The latter is associated with an opening 28 provided in the sound attenuation layer 17. In contrast to the lower die 1, the lower die 18 has neither a positive edge nor a cavity. In contrast to this, the upper die 29 associated with the lower die 18 comprises a cavity 30 that is delimited by a circumferential projection 31. In the region of its cavity 30, the upper die 29 comprises several depressions 32, 33, 34 and elevations 35, 36. The depressions 32, 33 face the elevations 19, 20 of the lower die 18 while the projection 24 of the lower die 18 in the closed state of the form tools projects into the conical depression 34. Furthermore, there are a plural number of smaller depressions 37 in the cavity 30 of the upper die 29 between the depressions 32, 33 and the depression 34.

The cavity 30 that is defined in the closed state of the form tools 18, 29 is larger than the cavity 3 that define the form tools 1, 2 in the closed state. In this arrangement the enlargement of the cavity is in particular evident at the margin of the heavy layer 6 and above the opening 25 in the heavy layer 6.

The sound attenuation layer 17 (sound absorber) to be connected with the heavy layer 6 can be made from porous and/or textile material, in particular from a nonwoven fabric and/or a foam material. The sound attenuation layer 17 shown in FIGS. 4 to 6 is made from a layer of foam material.

The layer of foam material 17 has a compression hardness σ_{d40} of no less than 4 kPa and a permanent set ranging from 3 to 6% (having previously been compressed by 50% and stored for 72 hours at 70° C.). Such a layer of foam material has a great ability to recover, which is advantageous for achieving the highest possible absorber volume after completion of the mould pressing procedure. The term “compression hardness” σ_{d40} refers to the compressive strain required for a deformation of 40% (compare DIN EN ISO 3386-1/2). The permanent set is defined in DIN EN ISO 1856. Accordingly, right parallelepipeds of 0.50 mm×50 mm×25 mm of a thickness of 25 mm are compressed by 50 or 75% between steel plates and are stored for 72 hours at normal climatic conditions and at 70° C. The permanent set is the extent of plastic deformation that is determined after unloading (permanent deformation) in %.

The sound attenuation layer 17 preferably comprises a flexible open-pore layer of PUR foam material of the polyether type. Said sound attenuation layer 17 preferably comprises a layer thickness of at least 10 mm and on the outside can be covered by a nonwoven material, for example a spunbonded nonwoven material.

The layer of foam material 17 is arranged in the form of a plate-shaped blank or foamed injection moulded part between the open form tools 18, 29, such that the cylindrical section 27 of the projection 24 of the lower die 18 is accommodated within the opening 28 provided in it. Placement of the sound attenuation layer or layer of foam material 17 preferably takes place by means of a robot. As an alternative, the layer of foam material can also be made from several blanks and/or foamed injection moulded parts. The blank or blanks or the foamed injection moulded part or parts are dimensioned such that when the form tools 18, 29 are closed, no foam material or nonwoven material on the circumferential projection 31 of the upper die 29 is cut off so that overall no waste material arises.

In the embodiment shown in FIGS. 4 to 6, the diameter of the opening 28 in the sound attenuation layer 17 is smaller than the diameter of the opening 25 in the heavy layer 6. Furthermore, the sound attenuation layer 17, and correspondingly the cavity 30 in the upper die 29, is dimensioned such that the circumference of the sound attenuation layer 17 projects beyond the circumference of the heavy layer 6 in one or several sections, or, if desired, over its entire circumference.

When the form tools 18, 29 are being closed the sound attenuation layer 17 is spot-welded to the heavy layer 6 in order to facilitate recycling of the produced composite component 38 according to types of material, namely the heavy layer 6 and the sound attenuation layer 17. Spot-welding the sound attenuation layer 17 to the heavy layer 6 takes place by means of several welding elements 39 that are limited in area and integrated in the upper die 29. In FIGS. 4 to 6 the welding elements 39 are diagrammatically shown as circles. Small electrical heating elements, ultrasound welding elements or high-frequency welding elements can be used as weld elements 39.

During spot welding, the sound attenuation layer 17 is at the same time thermally formed and is thus given the profile structure that corresponds to the cavity 30 of the upper die 29. To this effect several heating elements (not shown) are integrated in the upper die 29 in the regions of the elevations 35, 36 and depressions 32, 33, 34, 37. The heat output of the respective heating element is controlled such that the sound attenuation layer 17 is spot-welded to the heavy layer 6 only at specified locations that are limited in area, for example only at spots in the margin area of the composite component 38 and/or on points in the region of elevations or depressions in the composite component 38. To control or accelerate solidification of the weld points and thermal forming of the sound attenuation layer 17, cooling devices can also be integrated in the lower die 18 and/or in the upper die 29.

As soon as thermal forming of the sound attenuation layer 17 takes place and the weld points have sufficiently solidified the form tools 18, 29 are moved apart and the finished composite component 38 is removed. To facilitate removal, the lower die 18 also comprises several retractable and extendable ejection elements 16′.

The diagram shows that the heavy layer 6 and the sound attenuation layer 17 of the finished composite part 38 are interconnected in such a way that the heavy layer 6 adjoins the sound attenuation layer 17 of the finished composite component 38 parallel to its contours and without any gap. As a result of thermal forming the sound attenuation layer 17 comprises regions of different compression or thickness. The local thickness or compression of the sound attenuation layer 17 is selected depending on the respective acoustic requirements at the location where the composite component 38 is installed.

A further embodiment of the invention is described below with reference to FIGS. 7 to 12. In this embodiment partial welding together of the heavy layer 6′ and the sound attenuation layer 17 takes place with the same form tools 40, 41 with which previously the heavy layer 6′ has been produced by extrusion. However, unlike the situation in the embodiment according to FIGS. 1 to 6, the lower die 40 and the circumferential frame-shaped positive edge 42 are not formed in one piece but instead are separate, wherein the positive edge 42 that encloses the lower die 40 with little play can be raised and lowered relative to the lower die 40.

In order to produce the heavy layer 6′ of the composite component 38′ according to the invention, the positive edge 42 is first raised so that it forms an open cavity 3′ with the lower die 40, into which cavity—as is the case in the first-described embodiment—in the strand placement process a specified volume of a heavy layer material is placed as a plasticized compound 5 (compare FIG. 7).

After the plasticized heavy layer compound 5 has been placed into the open cavity 3′, the upper die 41 is lowered so that the compound 5 in the cavity defined by the upper die and the lower die as well as by the positive edge 42 is extruded into the form of the heavy layer 6′.

The lower die 40 again comprises several elevations 7′, 8′ which are associated with correspondingly formed depressions 9′, 10′ in the underside of the upper die 41. The diagram also shows that the heavy layer 6′ produced with the form tools 40, 41 comprises regions of different thickness.

To generate an opening in the composite component 38′ to be produced the lower die 40 also comprises a pin-shaped projection 12′ which is associated with a corresponding hole or recess 13′ in the upper die 41. The pin-shaped projection 12′ and the frame-shaped positive edge 42 each comprise circumferential cutting edges 43, 44.

As soon as the heavy layer 6′ has a sufficient nondeformability, the form tools 40, 41 are opened again. At the same time the positive edge 42 is lowered to such an extent that its top and the top of the lower die 40 are situated approximately on the same level. After this, a web section of a sound attenuation layer 17′ is placed between the open form tools 40, 41. As shown in FIG. 9 the web section of the sound attenuation layer 17′ can protrude beyond the outer edges of the form tools 40, 41.

Subsequently the form tools 40, 41 are closed again, wherein the cutting edge 44 of the pin-shaped projection 12′ penetrates the sound attenuation layer 17′ and punches out a piece of the layer 17′ (FIG. 10). While the sound attenuation layer 17′ and the heavy layer 6′ are compressed, the positive edge 42 is raised so that its circumferential cutting edge 43 cuts off the sections of the sound attenuation layer 17′, which sections protrude laterally from the form tools 40, 41 (compare FIGS. 10 and 11).

In this way the sound attenuation layer 17′ is embossed on top of the heavy layer 6′, wherein for point-welding together the sound attenuation layer 17′ and the heavy layer 6′ again several welding elements 39′ that are delimited in area are integrated in the upper die 41. In the drawing these welding elements 39′ are diagrammatically shown in the form of circles. At the same time as spot-welding, thermal deformation of the sound attenuation layer 17′ takes place. To avoid repetition, in this regard reference is made to the above explanations in relation to FIG. 5.

Finally, the form tools 40, 41 are moved apart again and the finished composite component 38′ is ejected for removal by means of the ejection elements 16″ integrated in the lower die 40.

The performance of the invention is not limited to the embodiments described above. Instead, several variants are imaginable which, even with a basically different design, make use of the scope and nature of the invention. For example, for spot-welding the heavy layer 6, 6′ together with the sound attenuation layer 17, 17′, the welding elements 39, 39′ can, additionally or as an alternative, also be integrated in the lower die 18 or 40.

1-20. (canceled)

21: A method for producing a sound-insulating composite component, in particular for motor vehicles, in which method the composite component (38) comprises a heavy layer (6) and a sound attenuation layer (17) connected with said heavy layer (6) and is made of a porous and/or textile material, comprising the steps of:
placing a certain volume of a heavy-layer material as a plasticized compound (5) into an open cavity (3) of a press comprising a lower die (1) and an upper die (2);
closing the press, wherein the plasticized compound (5) is extrusion-pressed into the form of the heavy layer (6) in the cavity defined by the lower die and the upper die;
opening the press after the heavy layer has attained nondeformability;
arranging the sound attenuation layer (17) in the form of a web, a blank or an injection moulded part on the heavy layer (6);
wherein
the heavy layer (6) and the sound attenuation layer (17) are partially welded together in the press or in a further press in that several welding elements that are delimited in area and that are integrated in the press or in the further press are activated;
during partial welding to the heavy layer (6) the sound attenuation layer (17) is thermally formed so that the sound attenuation layer (17) is given a profile structure; and
the sound attenuation layer (17) is dimensioned in such a way in relation to the heavy layer (6) that the circumference of the sound attenuation layer (17) reaches beyond the circumference of the heavy layer (6) on one or several sections or on the entire circumference.

22: The method according to claim 21,
wherein
the heavy layer (6) and the sound attenuation layer (17) are interconnected in such a way that the heavy layer (6) adjoins the sound attenuation layer (17) parallel to its contours and without any gap.

23: The method according to claim 21,
wherein the heavy layer (6) is designed such that it comprises regions of different thickness and/or density.

24: The method according to claim 21,
wherein
the sound attenuation layer (17) is formed of a flexible open-pore layer of foam material.

25: The method according to claim 21,
wherein
the sound attenuation layer (17) is made from PUR foam material of the polyether type.

26: The method according to claim 21,
wherein
the sound attenuation layer (17) is made from a nonwoven-fabric-coated foam material layer.

27: The method according to claim 21,
wherein
the sound attenuation layer (17) is designed such that it comprises regions of different compression.

28: The method according to claim 21,
wherein
the sound attenuation layer (17) is designed such that it comprises regions of different thickness and/or density.

29: The method according to claim 21,
wherein
the sound attenuation layer (17) is made from a foam material that has a compression hardness σ_{d40} of no less than 4 kPa and a permanent set ranging from 3 to 6%, having previously been compressed by 50% and stored for 72 hours at 70° C.

30: The method according to claim 21,
wherein
for partial welding together of the heavy layer (6) and the sound attenuation layer (17) the lower die (1) and/or the upper die (2) are exchanged for a lower die (18) or an upper die (29) respectively, which results in an enlargement of the cavity defined by the lower die (1) and the upper die (2).

31: The method of claim 30,
wherein
the enlargement of the cavity takes place at the margin of the heavy layer (6) and/or in the region of an opening (25) in the heavy layer (6).

32: A sound-insulating composite component, in particular for motor vehicles, comprising a heavy layer (6) and a sound-attenuation layer (17) that is connected with said heavy layer (6) and is made of porous and/or textile material, wherein the heavy layer (6) is formed as a moulded part by extrusion-pressing a plasticized plastic compound (5), fed-in in the strand placement process, from the group of thermoplastic elastomers, and comprises regions of different thickness and/or density
wherein
the heavy layer (6) is welded to the sound attenuation layer (17) only in some parts, wherein the sound attenuation layer has a profile structure that is formed by thermal forming, and at least in some sections the circumference of the sound attenuation layer (17) reaches beyond the circumference of the heavy layer (6).

33: The composite component of claim 32,
wherein the heavy layer (6) adjoins the sound attenuation layer (17) parallel to its contours and without any gap.

34: The composite component according to claim 32,
wherein the sound attenuation layer (17) is made from a flexible open-pore layer of foam material.

35: The composite component according to claim 32,
wherein the sound attenuation layer (17) is made from PUR foam material of the polyether type.

36: The composite component according claim 32,
wherein the sound attenuation layer (17) is made from a nonwoven-fabric-coated foam material layer.

37: The composite component according to claim 32, wherein the sound attenuation layer (17) comprises regions of different compression.

38: The composite component according to claim 32, wherein the sound attenuation layer (17) is made of a foam material that has a compression hardness σ_{d40} of no less than 4 kPa and a permanent set ranging from 3 to 6%, having previously been compressed by 50% and stored for 72 hours at 70° C.

39: The composite component according to claim 32,
wherein the heavy layer (6) and the sound attenuation layer (17) each comprise at least one opening (25, 28), wherein the two openings (25, 28) form a joint opening, and the diameter of the opening (28) in the sound attenuation layer (17) is smaller than the diameter of the opening (25) in the heavy layer (6).
